(19) United States
(12) Patent Application Publication
(10) Pub. No.: US 2004/0238250 A1
(43) Pub. Date: Dec. 2, 2004

(54) Motorcycle cruise control installation kit

(76) Inventors: David Young, Emporia, KS (US); Roy Monroe, Emporia, KS (US)

Correspondence Address: DAVID YOUNG, RT 5, BOX 55Y, EMPORIA, KS, 66801, US

(21) Appl. No.: 10/445,697

(22) Filed: May 27, 2003

(51) Int. Cl. B60K 31/00

(52) U.S. Cl. 180/170

(57) ABSTRACT

The present invention provides a method of adapting a vehicle manufacturer's cruise control module that is designed for a specific model(s) to be easily adapted to that same (or other) vehicle manufacturer's other model lines, whereon the vehicle manufacturer does not offer cruise control as of the date of this patent filing.

### FIELD OF THE INVENTION

Mechanical and electrical parts which enable vehicle manufacturer supplied cruise control to be added to a motorcycle to improve rider safety and comfort when operating vehicle.

### BACKGROUNG OF THE INVENTION

Cruise control like found in most modern automobiles is a one-piece, electronic, self-contained unit with the electronic “brains” and the mechanical control of the throttle (carburetor or fuel injection) all contained in one, small unit. Some manufacturers of motorcycles offer this almost identical “factory installed” cruise control, but only for specific styles or models of their motorcycles. Limited research has shown a demand to expand this offering beyond that which is currently offered by the motorcycle manufacturers. Inquiries to manufacturers have met resistance, with comments like “we don't offer cruise control for that model”.

There are available some items marketed as “cruise control” that simply “lock” the throttle in any position. These are not “real” cruise control as commonly thought of as found in most modern automobiles that feature “set”, “resume”, “cancel”, etc. They also do not maintain vehicle speed, simply throttle position. This means the vehicle slows down under load (uphill) and speeds up with no load (downhill). The “real” automotive cruise control maintains speed, not throttle position. In fact, the automotive cruise control offers many safety features that turn off the cruise control based on instinctive reflex action, such as taping the brake, or disengaging the clutch. Some of the items marketed as “cruise control” that simply “lock” the throttle in any position must be manually “unlocked” and in fact may be unsafe in an emergency situation.

There does not exist an installation kit to enable using a motorcycle manufacturer's cruise control to be mounted to “other” models of a given manufacturer.

Thus, an unsatisfied need exist for an “after-market” cruise control installation kit to satisfy rider demand for this safety/comfort feature.

### SUMMARY OF THE INVENTION

The present invention provides an installation kit containing bracket(s), singular or multiple parts, to mount and conceal (hide or blend-in) the motorcycle manufacturer's electronic “brain”/throttle control. The electronic “brains”/throttle control itself is not part of this invention. This invention is unique in that it uses the electronic “brain”/throttle control already available from the vehicle manufacturer for their other models. As an example: Harley Davidson offers cruise control for its' “touring” models only, not for its' other models; Softail, Dyna, Vrod, or Sportster. This invention, ie: mounting bracket(s) and cover is/are not currently available anywhere.

The present invention provides an installation kit containing the necessary electrical wiring and connections needed to connect the electronic “brains”/throttle control to the vehicle. As an example: Harley Davidson pre-wires cruise control for its' “touring” models only, and not for its' other models; Softail, Dyna, Vrod, or Sportster. This invention, ie: the required wiring harness is not available anywhere. The specific brand and style of the electrical connectors, and the specific brand and style of the wire itself are not a part of this invention.

### BREIF DESCRIPTION OF THE DRAWINGS

FIG. 1 is an example of the front view of the bracket, in accordance with an embodiment of the present invention, used to mount the electronic cruise control “brains”/throttle control to the vehicle, not to scale, shape and dimensions of mounting bracket . . . number, location, and size of holes . . . will vary depending on brand and model of motorcycle. (drawings page 1 of 4)

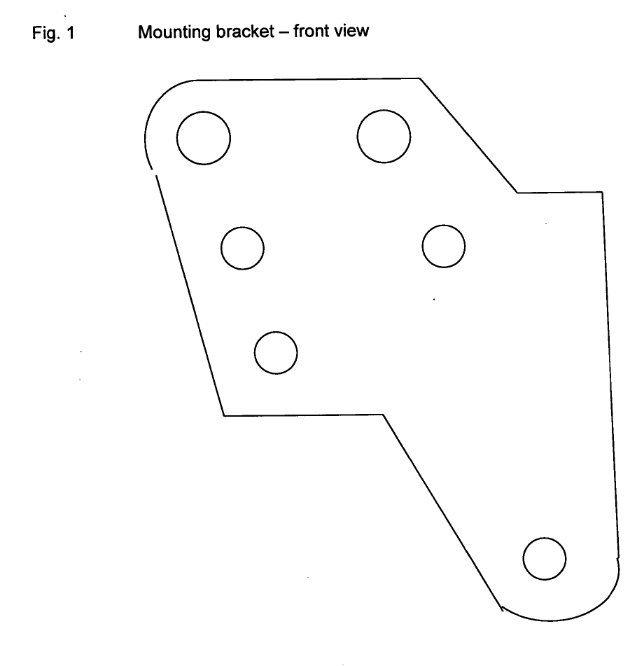

FIG. 2 is an example of a side view of the bracket, in accordance with an embodiment of the present invention, used to mount the electronic cruise control “brains”/throttle control to the vehicle, not to scale, shape and dimensions will vary depending on brand and model of motorcycle. (drawings page 2 of 4)

FIG. 3 is an example of the cover, in accordance with an embodiment of the present invention, used to conceal the electronic cruise control “brain”/throttle control, not to scale, shape and dimensions will vary depending on brand and model of motorcycle, and motorcycle manufacturer's vendor supplying the cruise control module. (drawings page 3 of 4)

FIG. 4 is and example of the electronic wiring harness, in accordance with an embodiment of the present invention, required to connect the electronic cruise control “brains”/throttle control to the vehicle. Actual functions and control will vary depending on brand and model of motorcycle, and motorcycle manufacturer's vendor supplying the cruise control module. (drawings page 4 of 4)

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms and employed herein, they are used in a generic and descriptive sense only and not for the purpose of limitation.

The following paragraphs describe the components of the cruise control installation kit.

The Mounting Bracket(s)

In a preferred embodiment the installation kit contains a single-part mounting bracket to attach the electronic “brain”/throttle control to the motorcycle. In an alternative embodiment the installation kit would contain a multiple-part mounting bracket to accomplish the same end results.

In a preferred embodiment this mounting bracket would primarily be made of steel with a chrome finish. In an alternative embodiment this mounting bracket could easily be made or other material such as but not limited to stainless steel, fiberglass, or aluminum or a combination of any materials with a variety of finishes such as but not limited to paint, polished aluminum, or a combination of any.

In a preferred embodiment this mounting bracket could be mounted in various positions on either left or right side, front or back, top or bottom of vehicle. In an alternative embodiment this mounting bracket could be mounted anywhere on the vehicle.

In a preferred embodiment this mounting bracket would have pre-drilled holes to match existing bolt patterns available on the motorcycle so that existing bolts could be removed from the motorcycle, the bolts placed through holes in the mounting bracket and then the bolts replaced in the original holes in the motorcycle.

In an alternate embodiment, new holes in the mounting bracket or new holes in the motorcycle may be required, as well as new or longer or shorter bolts.

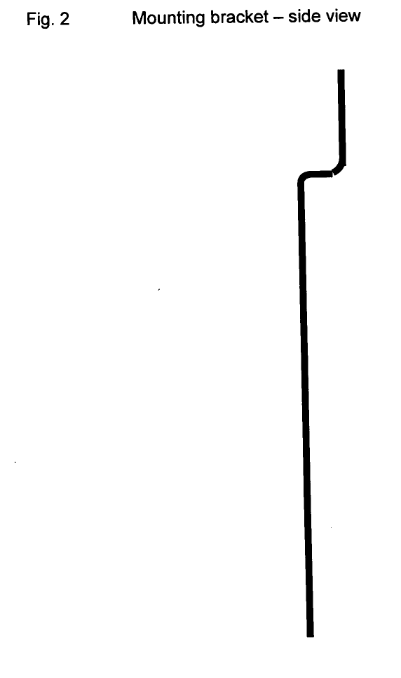

FIG. 2 is an example of a preferred mounting bracket, but is only representative of one of many designs that it will be readily apparent that may be designed for specific installation requirements, depending of specific motorcycle manufacturer, motorcycle model or year of manufacturer, or manufacturer's vendor that supplies the cruise control module.

The Cover(s)

In a preferred embodiment the cover will conceal the majority of the electronic “brain”/throttle control and wiring harness, but in an alternative embodiment this cover could conceal all or none or any part of the electronic “brain”/throttle control and/or wiring harness.

In a preferred embodiment the cover will be mounted with either bolts, screws, or an adhesive material, but in an alternative embodiment, any method of mounting the cover may be used.

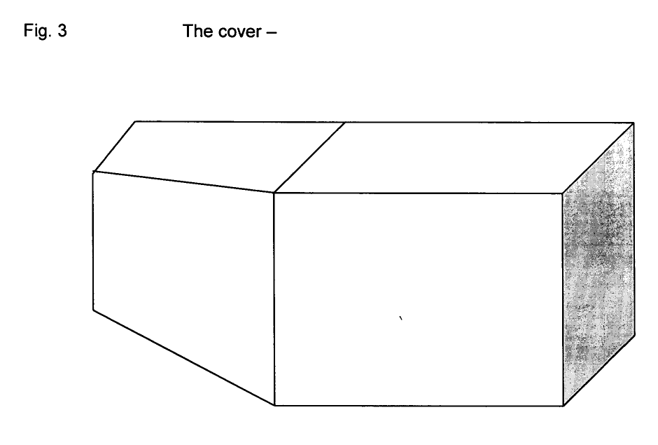

FIG. 3 is an example of a preferred cover to conceal the cruise control module, but is only representative of one of many designs that will be readily apparent that may be designed for specific installation requirements, depending of specific motorcycle manufacturer, motorcycle model or year of manufacturer, or manufacturer's vendor that supplies the cruise control module.

The Wiring Harness(S)

In a preferred embodiment the installation kit contains a single, assembled wiring harness. But in an alternative embodiment multiple wiring harnesses may be needed to complete the installation.

In a preferred embodiment the installation kit contains a single, assembled wiring harness that will connect to the existing vehicle wiring harness(s), the electronic “brain”/throttle control, and all and all other required components with no or very little modification. But it will be readily apparent to one of ordinary skill in the art that various vehicles use different electrical designs and that various degrees of user modification may be required.

In a preferred embodiment the installation kit contains wiring harness(s) with all connectors and wire of the same style and brand. But it will be readily apparent to one of ordinary skill in the art that various vehicle manufacturers use different styles and brands of electrical connectors, even within the same manufacturer and model line. The installation kit may contain different style and brand of connectors and wire to meet the intended installation. The styles and brands of connectors and wire are not part of this invention.

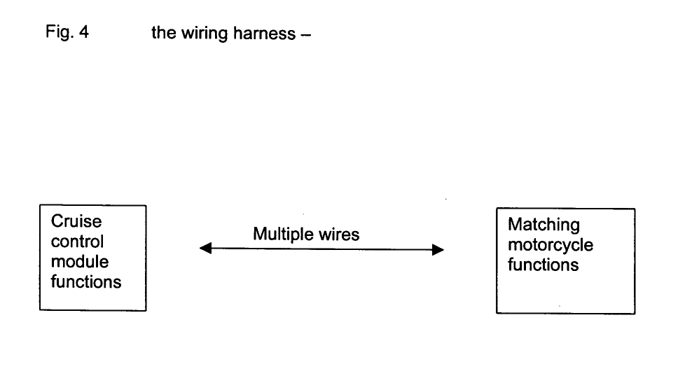

FIG. 4 is an example of a preferred wiring harness, but is only representative of one of many designs that it will be readily apparent that may be designed for specific installation requirements.

That which is claimed:

1. A means or device, that is, a bracket(s) for mounting the motorcycle manufacturer supplied cruise control on the motorcycle manufacturer's model lines that do not offer cruise control as of this application date.

2. A means or device, that is, a cover(s) for concealing the cruise control on a motorcycle manufacturer's model lines that do not offer cruise control as of this application date.

3. A means or device, that is, a wiring harness(s) to electronically connect a motorcycle manufacturer supplied cruise control to the motorcycle manufacturer's model lines that do not offer cruise control as of this application date.
